(19) United States
(12) Patent Application Publication
(10) Pub. No.: US 2010/0283008 A1
(43) Pub. Date: Nov. 11, 2010

(54) Carbon Nanotube Compositions and Methods for Production Thereof

(75) Inventors: Juan G. Duque, Houston, TX (US); Matteo Pasquali, Houston, TX (US); Howard K. Schmidt, Cypress, TX (US); Laurent Cogent, Cedex (FR); A. Nicholas G. Parra-Vasquez, Oxnard, CA (US)

Correspondence Address: WINSTEAD PC, P.O. BOX 50784, DALLAS, TX, 75201, US

(73) Assignee: WILLIAM MARSH RICE UNIVERSITY, Houston, TX (US)

(21) Appl. No.: 12/679,864

(22) PCT Filed: Sep. 24, 2008
(86) PCT No.: PCT/US08/77531

§ 371 Date: Jun. 28, 2010

Related U.S. Application Data
(60) Provisional application No. 60/974,717, filed on Sep. 24, 2007.

(51) Int. Cl. C09K 11/02; B01J 13/06

(52) U.S. Cl. 252/301.36; 427/213.31; 977/750; 977/752; 977/742; 977/746; 977/847; 977/902; 977/904

(57) ABSTRACT

Compositions comprising at least one type of carbon nanotube, at least one surfactant, and at least one polymer are disclosed. The compositions provide stable fluorescence over a wide range of pH in various embodiments. In some embodiments, the compositions are biocompatible. Methods for preparing the compositions from at least one pre-formed polymer are disclosed. Methods for preparing the compositions from at least one monomer are disclosed. Heating methods utilizing the compositions are disclosed.

### CROSS-REFERENCE TO RELATED APPLICATIONS

This application claims priority to U.S. provisional patent application 60/974,717 filed Sep. 24, 2007, which is incorporated by reference as if written herein in its entirety.

### STATEMENT REGARDING FEDERALLY SPONSORED RESEARCH

This work in this application was supported by the Robert A. Welch Foundation (awards C-1668 and R4093J 715000), the NSF Center for Biological and Environmental Nanotechnology (awards EEC-0118007 and EEC-0647452), the DGA (award ERE060016), and the Fulbright Foundation.

### PARTIES TO A JOINT RESEARCH AGREEMENT

This work was conducted under a joint research agreement established between William Marsh Rice University (Houston, Tex. USA) and Centre National de la Recherche Scientifique (Paris, France).

### BACKGROUND

Carbon nanotubes are a well studied class of nanomaterial due to their useful thermal, physical, optical, and electronic properties. In particular, single-wall carbon nanotubes (SWNTs) exhibit metallic-, semi-metallic-, or semiconductor-type behavior depending on their chirality. Carbon nanotubes show near-infrared luminescence in certain instances. The spectroscopic properties are known to depend on the solution environment in which the carbon nanotubes reside. For example, changes in acidity can induce bleaching of the carbon nanotube UV-VIS absorption, fluorescence quenching, and spectral shifts. Stable spectral properties may be used to monitor effects such as electron transfer, protonation, charge-transfer reactions and even individual molecular reactions. Spectroscopic sensitivity of carbon nanotubes is notable under biological conditions, such as those used for drug delivery, biosensors, biomedical devices, and cell biology, since viable cells and tissues need specific environmental conditions such as temperature, salt concentration, and pH in order to survive.

Low solubility of carbon nanotubes in most organic and aqueous solvents has hampered their development in many proposed applications. Sonicating carbon nanotubes with surfactants is one method that has been successfully used to create stable suspensions of carbon nanotubes. Photoluminescence properties of these surfactant-suspended carbon nanotubes have been investigated and mirror the pronounced acid sensitivity described above. Photoluminescence properties are also influenced by the surfactant concentration. Compositions comprising surfactants and carbon nanotubes alone are, generally not thought to be biocompatible. Derivatizing carbon nanotubes with functional groups on the end caps, sidewalls, or both has also been used to improve solubility. Functionalization, especially sidewall functionalization, can dramatically alter the photoluminescence properties compared to unfunctionalized carbon nanotubes. These solvation techniques produce isolated carbon nanotubes from as-produced carbon nanotube bundles.

Luminescent compositions comprising carbon nanotube have been prepared. Treating a low pH suspension of SWNTs and surfactant with poly(vinyl pyrrolidone) (PVP) provides partial restoration (˜10%) of the absorption and fluorescence properties observed at neutral pH. A carbon nanotube suspension having weak photoluminescence has also been obtained by treatment of Pluronics coated carbon nanotubes with a mixture of unidentified proteins from biological sera.

In view of the foregoing, development of solubilizing compositions for carbon nanotubes that maintain strong and stable photoluminescence over a wide pH range would be of substantial utility. Such compositions and methods of production thereof would be of considerable value in applications favoring biocompatibility, such as in cell biology, biomedical, medical imaging, and medical therapeutic applications.

### SUMMARY

In various embodiments, compositions are disclosed comprising at least one type of carbon nanotube, at least one surfactant, and at least one polymer. In some embodiments herein, the compositions further comprise an aqueous suspension of the composition.

In other various embodiments, methods are disclosed, wherein the methods comprise: obtaining at least one type of carbon nanotube; suspending the at least one type of carbon nanotube in an aqueous solution comprising at least one surfactant; adding at least one polymer; and coating the at least one type of carbon nanotube with the at least one polymer to create at least one type of coated carbon nanotube.

In still other embodiments, methods are disclosed, wherein the methods comprise: obtaining at least one type of carbon nanotube; suspending the at least one type of carbon nanotube in an aqueous solution comprising at least one surfactant; adding at least one monomer of at least one polymer; coating the at least one type of carbon nanotube with the at least one monomer; and polymerizing the at least one monomer to create at least one type of coated carbon nanotube.

In certain other embodiments, heating methods are disclosed, wherein the methods comprise: providing a composition comprising at least one type of carbon nanotube, at least one surfactant, and at least one polymer; and irradiating the composition with at least one frequency of electromagnetic radiation.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings, in which:

FIG. 1 shows an embodiment of a 2-D contour plot of fluorescence intensity versus the excitation and emission wavelength before (pH=7) and after (pH=2) addition of 1 M HCl to a suspension of SWNT/SDBS/PVP.

FIG. 2 shows an embodiment of a 1-D fluorescence spectra of a suspension of SWNT/SDBS/PVP at pH=7 and pH=2 with a 660 nm excitation wavelength.

FIG. 3 shows an embodiment of the Raman spectral peaks of the radial breathing mode of a suspension of SWNT/SDBS/PVP at pH=7 and pH=2 following excitation at 785 nm.

FIG. 4 shows embodiments of the fluorescence spectra of SWNT/SDBS and SWNT/SDBS/PVP suspensions recorded at pH=7, following excitation at 785 nm and normalization to the absorbance spectrum of a (7,6) SWNT suspended in SDBS at pH=7.

FIG. 5 shows embodiments of the fluorescence spectra of SWNT/SDBS and SWNT/SDBS/PVP suspensions recorded at pH=2, following excitation at 785 nm and normalization to the absorbance spectrum of a (7,6) SWNT suspended in SDBS at pH=7.

FIG. 6 shows an embodiment of the kinetic time course of 1120 nm fluorescence of SWNT/SDBS, SWNT/PVP, and SWNT/SDBS/PVP following addition of acid.

FIG. 7 shows embodiments of the fluorescence intensity of SWNT/SDBS and SWNT/SDBS/PVP as measured within a pH range of 1 and 11.

FIG. 8 shows embodiments of AFM images of SWNT/SDBS/PVP prepared at pH=7 and pH=2, following surface cleaning of excess surfactant and PVP.

FIG. 9 shows embodiments of AFM images of SWNT/SDBS/PVP prepared at pH=7 and pH=2 without surface cleaning of excess surfactant and PVP.

FIG. 10 shows an embodiment of the distribution of heights measured from AFM images of SWNT/SDBS/PVP at pH=7 and pH=2 following surface cleaning of excess surfactant and PVP.

FIG. 11 shows embodiments of near-IR microscopy images of SWNT/SDBS/PVP at pH=7 and pH=2.

FIG. 12 shows embodiments of the cumulative distributions of fluorescent spot signal amplitudes for SWNT/SDBS/PVP at pH=7 and pH=2.

FIG. 13 shows an embodiment of the ratio of integrated areas of SWNT/SDBS/PVP to SWNT/SDBS as a function of PVP molecular weight, following excitation at 660 nm and pH=7.

FIG. 14 shows embodiments of AFM images obtained from SWNT/SDBS/PVP prepared by in situ polymerization of vinyl pyrrolidone at pH=7 and pH=2 after surface cleaning.

FIG. 15 shows embodiments of the relative fluorescence intensity of SWNT/SDBS/PVP prepared by in situ polymerization over a pH range of 1 to 11, compared to SWNT/SDBS and SWNT/SDBS/PVP prepared from pre-formed PVP.

FIG. 16 shows an embodiment of a proposed mechanism by which fully polymerized PVP and vinyl pyrrolidone interact with SWNT/SDBS micelles.

FIG. 17 shows embodiments of a SWNT/SDBS/PVP suspension, a lyophilized solid obtained from the suspension, and redissolution of the solid in water.

FIG. 18 shows embodiments of the positions of fluorescence spectral peaks from SWNT/SDBS/PVP before lyophilization and after redissolution.

FIG. 19 shows an embodiment of SWNT/SDBS/PVP near-IR luminescence images of a HEK293 cell recorded at two different foci following 5 minutes of incubation.

FIG. 20 shows an embodiment of a fluorescence spectrum obtained from an individual SWNT/SDBS/PVP luminescent spot at the surface of a HEK293 cell following 5 minutes of incubation.

### DETAILED DESCRIPTION

In the following description, certain details are set forth such as specific quantities, sizes, etc. so as to provide a thorough understanding of the present embodiments disclosed herein. However, it will be obvious to those skilled in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing a particular embodiment of the disclosure and are not intended to be limiting thereto. Drawings are not necessarily to scale.

While most of the terms used herein will be recognizable to those of skill in the art, it should be understood that when not explicitly defined, terms should be interpreted as adopting a meaning presently accepted by those of skill in the art.

In any of the various embodiments disclosed hereinbelow, references are made to different types of carbon nanotubes. It is to be understood that in any of the various embodiments disclosed hereinbelow that carbon nanotube types may refer to single-wall carbon nanotubes (SWNT), double-wall carbon nanotubes, multi-wall carbon nanotubes, unfunctionalized carbon nanotubes, functionalized carbon nanotubes, end-cap functionalized carbon nanotubes, sidewall functionalized carbon nanotubes, and shortened carbon nanotubes, for example. Functionalization of carbon nanotubes may be accomplished by methods known to those of skill in the art. Shortened carbon nanotubes may be prepared in a non-limiting example by oxidative treatment, such as with a mixture of nitric acid and sulfuric acid. A single type of carbon nanotube may be used in the various embodiments hereinbelow. Alternatively, at least one type of carbon nanotube may be used in the various embodiments hereinbelow. In certain embodiments, two or more types of carbon nanotubes are used in the embodiments hereinbelow. It is well known in the art that carbon nanotubes as produced may be formed in bundles or ropes. In certain embodiments disclosed hereinbelow, the carbon nanotubes are debundled. In certain other embodiments, the carbon nanotubes comprise essentially debundled carbon nanotubes. Essentially debundled, as used herein, refers to a condition in which at least 50% of the carbon nanotubes exist as individuals. In certain embodiments, essentially debundled carbon nanotubes comprise at least 90% of the carbon nanotubes existing as individuals. In certain embodiments disclosed hereinbelow, compositions and methods comprising SWNTs are disclosed.

In any of the various embodiments disclosed hereinbelow, references are made to certain polymers. In certain embodiments, these polymers are biocompatible. Biocompatible polymers may include but are not limited to poly(vinyl pyrrolidone) (PVP), poly(ethylene oxide) (PEO), and poly(acrylic acid) (PAA). In certain embodiments, a biocompatible polymer comprises a water soluble polymer. Biocompatible polymers provide advantageous water solubility in certain applications. One skilled in the art will recognize that the while the disclosure may be practiced with water soluble or biocompatible polymers as discussed hereinbelow, the disclosure should not be considered limiting in that regard. In certain applications, one skilled in the art will recognize that many other polymers and their monomers may be beneficial in practicing the disclosure.

In certain embodiments herein, a composition is disclosed comprising at least one type of carbon nanotube, at least one surfactant, and at least one polymer. In some embodiments herein the composition further comprises an aqueous suspension of the composition.

It is well known in the art that surfactants may be used to suspend carbon nanotubes in an aqueous environment. Surfactants may be neutral surfactants, cationic surfactants, anionic surfactants, and zwitterionic surfactants. In certain embodiments of the compositions disclosed herein, at least one surfactant comprises at least one anionic surfactant. Exemplary but non-limiting classes of anionic surfactants include, but are not limited to organic compounds based upon sulfate, sulfonate, and carboxylate anions. In anionic surfactants, these anions comprise a hydrophilic head group, which is bound to a hydrophobic tail. In some embodiments of the compositions disclosed herein, the compositions comprise at least one anionic surfactant selected from a group consisting of sulfates, sulfonates, carboxylates, and combinations thereof. Exemplary but non-limiting examples of anionic surfactants may include, but are not limited to, sodium dodecyl sulfate (SDS), ammonium lauryl sulfate, sodium laureth sulfate, sodium dodecylbenzene sulfonate (SDBS), alkyl sulfate salts, alkyl benzene sulfonate salts, fatty acid salts, and combinations thereof. In certain embodiments of the compositions disclosed herein, at least one anionic surfactant is selected from a group consisting of SDS, SDBS, and combinations thereof. One skilled in the art will recognize that a variety of anionic surfactants may be used equivalently within the spirit and scope of the disclosure.

Certain applications of carbon nanotubes in biological or medical systems may be facilitated by making the carbon nanotube compositions biocompatible. As used herein, biocompatible may refer to a condition in which the carbon nanotubes or compositions derived therefrom do not produce substantial toxicity in a living organism. Carbon nanotubes or compositions derived therefrom may also be biocompatible if they exert an observable effect when administered to a living organism. Such administration to a living organism may be conducted through methods known to those of skill in the art. Carbon nanotubes or compositions derived therefrom may also be biocompatible if they demonstrate an observable property under biological conditions. Biological conditions may include a wide range of properties known to those of skill in the art, and as used herein may include, but are not limited to, those specific environmental conditions conducive for tissue and cellular viability, such as temperature, pH, and ionic strength. In certain embodiments disclosed herein, compositions comprising carbon nanotubes are biocompatible. The compositions disclosed herein are advantageous over carbon nanotube compositions comprising a surfactant but not a polymer. The latter compositions comprising a surfactant only are not biocompatible or have limited biocompatibility. In contrast, the carbon nanotube compositions disclosed herein may be biocompatible over a wide range of conditions. In certain embodiments, the carbon nanotube compositions may be biocompatible as a consequence of having at least one biocompatible polymer comprising the composition.

Interaction of electromagnetic radiation with carbon nanotubes is a beneficial property that may be exploited in potential applications of these entities. In certain embodiments of the compositions disclosed herein, the compositions are an absorber of at least one type of electromagnetic radiation. In some embodiments, the at least one type of electromagnetic radiation is chosen from microwave frequency radiation and radio frequency radiation. Emission of electromagnetic radiation by carbon nanotubes is also a beneficial property of these entities. In certain embodiments herein, emission of electromagnetic radiation comprises fluorescent emission. In non-limiting examples, fluorescent emission of carbon nanotubes may be used for sensing applications, such as locating the carbon nanotubes in a biological environment, within a living organism, or bound to a cell surface. In certain embodiments disclosed herein, fluorescent emission occurs from SWNTs.

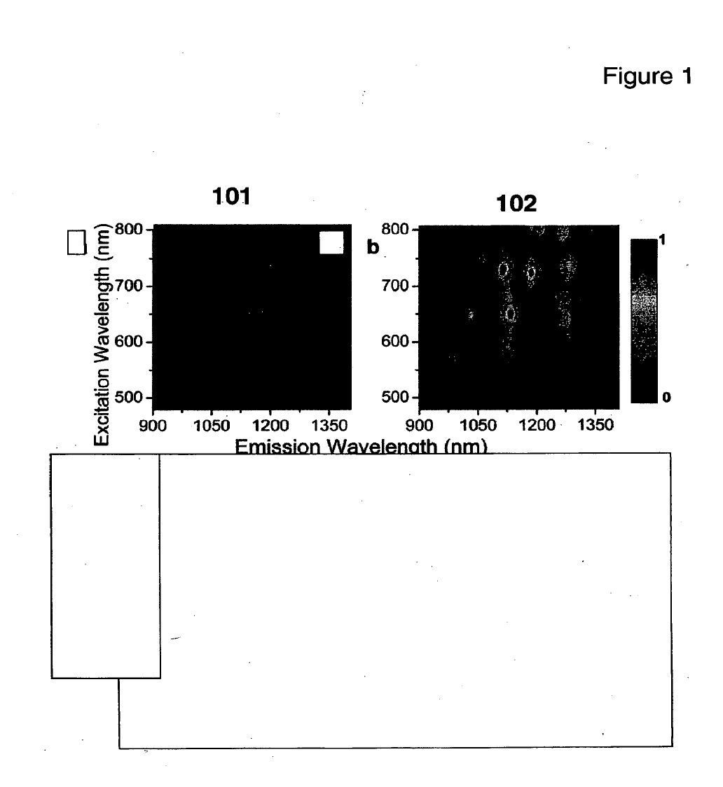

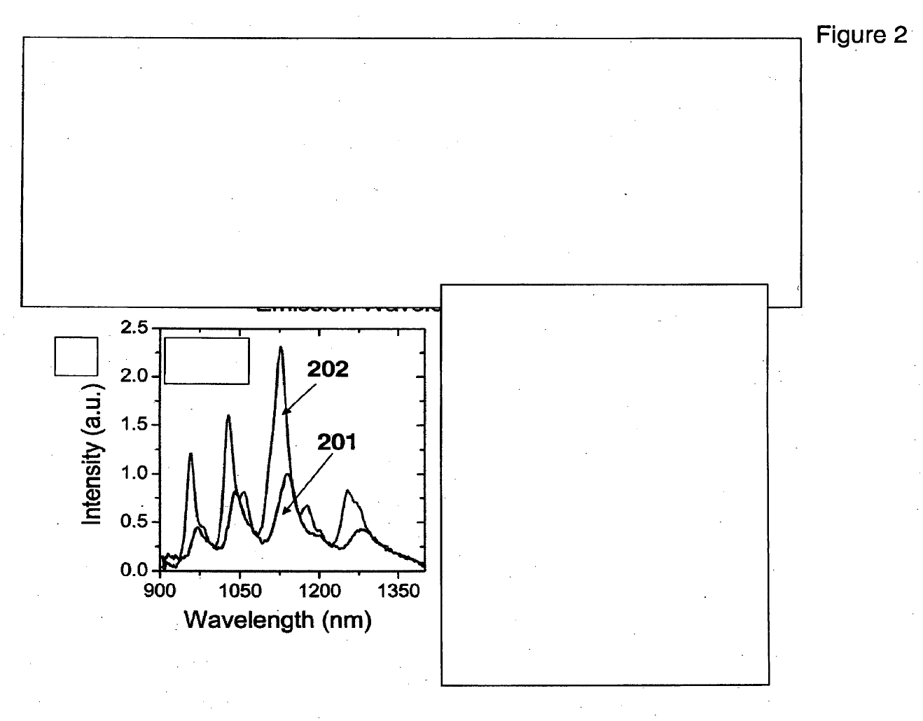

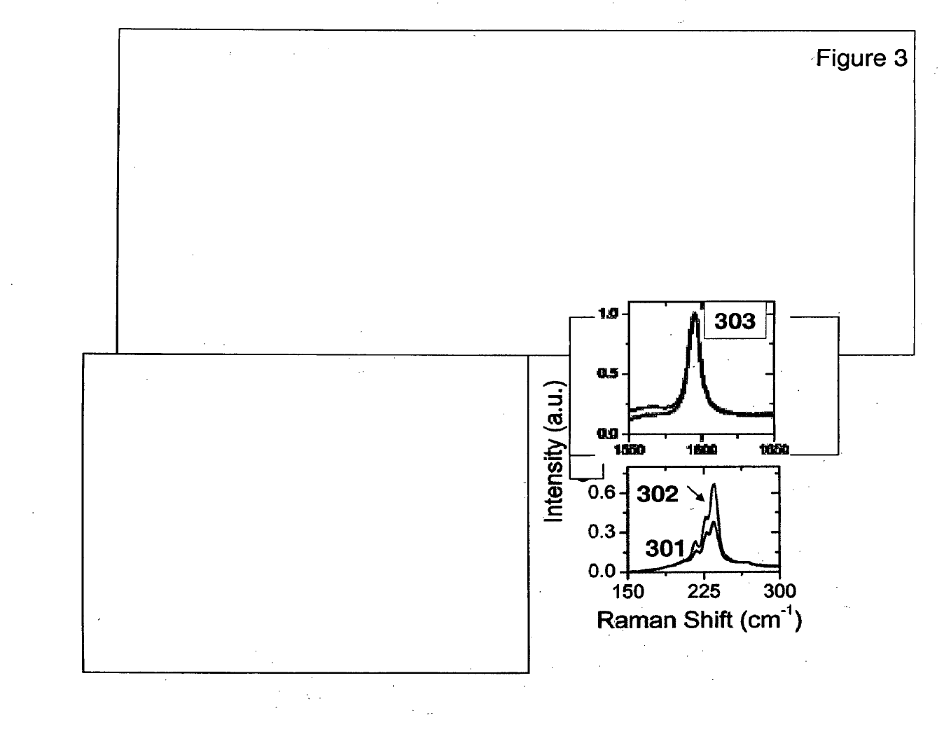

It is well known in the art that fluorescent emission of carbon nanotubes is dependent upon the environment in which they are dissolved or suspended. In particular, the specific conditions most favorable for biocompatibility may result in unfavorable variance of the fluorescent emission properties of the carbon nanotubes. For example, fluorescence of SWNTs suspended with anionic surfactant is known to vary considerably with changes in pH. Particularly at low pH, photobleaching of SWNT fluorescence is known to occur. The compositions disclosed herein are advantageous in providing strong fluorescence over a wide range of pH. Some of the compositions disclosed herein maintain relatively constant fluorescence over a wide range of pH. In certain embodiments, the compositions herein preserve fluorescence from at least one type of carbon nanotube between a pH of about 1 to about 11. FIG. 1 shows an embodiment of 2-D contour plots of fluorescence intensity versus the excitation and emission wavelength before (101, pH=7) and after (102, pH=2) the addition of 1 M HCl to the compositions described herein. FIG. 2 shows an embodiment of 1-D fluorescence spectra of the compositions described hereinabove at pH=7 (201) and pH=2 (202) from a 660 nm excitation wavelength. FIG. 2 demonstrates the utility of the compositions disclosed herein with regard to their fluorescence properties. Strong fluorescent emission is maintained at all wavelengths tested, even under strongly acidic conditions. Beneficially, the fluorescent intensity is enhanced even under acidic conditions by a factor of about two. As shown in FIG. 2, each peak of the fluorescence spectrum was blue shifted by about 25 nm upon acidification, and overall peak widths were somewhat narrower than those obtained at pH=7. Moreover, embodiments of Raman spectra of the carbon nanotube compositions shown in FIG. 3 demonstrated no change in carbon nanotube bundling upon acidification from pH=7 (301) to pH=2 (302) as evidenced by the area under the SWNT radial breathing mode in both spectra. The location and absence of G-peak shift in Raman spectrum 303 also indicated that SWNT protonation did not occur after acidification. Similar spectral enhancements and shifts were observed for other acids, such as phosphoric, nitric, and sulfuric acids. Likewise, similar spectral effects were observed whether SDS or SDBS was used.

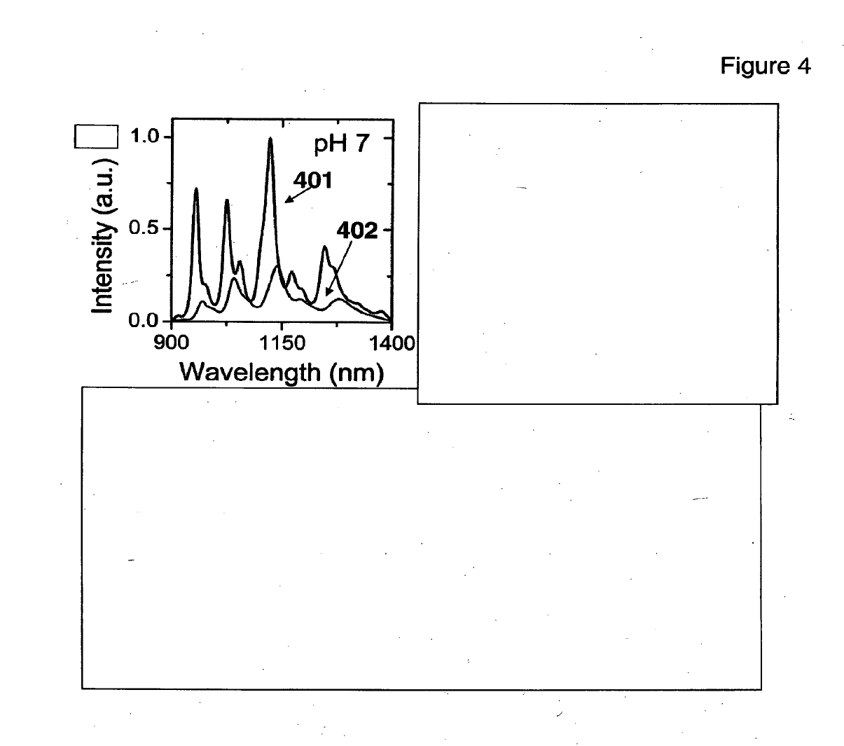

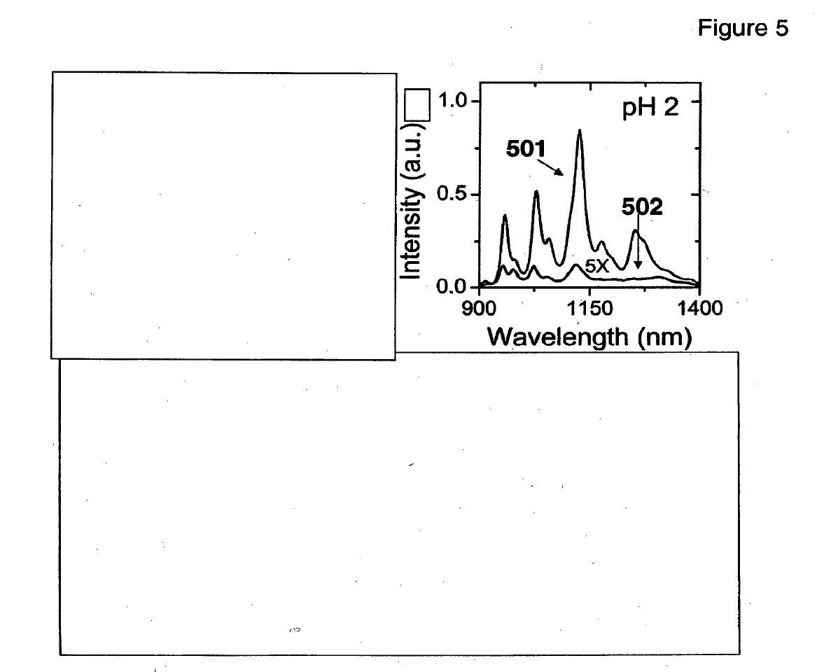

In order to elucidate the possible mechanism of SWNT/SDBS/PVP luminescence enhancement, the behavior of SWNT/SDBS and SWNT/SDBS/PVP suspensions were compared at pH=7 and pH=2 as shown in FIGS. 4 and 5, respectively. As shown in FIG. 4, addition of PVP to the SWNT/SDBS suspensions resulted in decreased in fluorescence intensity, accompanied by a red shift and spectral broadening. As previously described, SWNT/SDBS fluorescence intensity 401 was higher than that demonstrated by SWNT/SDBS/PVP 402. As shown in FIG. 5, however, the fluorescence intensity of SWNT/SDBS/PVP 501 was higher than that demonstrated by SWNT/SDBS 502. In contrast to the behavior typically observed with SWNT fluorescence with pH, the SWNT/SDBS/PVP compositions displayed higher fluorescence intensity at acidic pH compared to neutral pH. In the various embodiments shown, the magnitude of SWNT fluorescent enhancement was about 80% of that observed for SWNT/SDBS solutions at neutral pH. Further, when SWNT/SDBS compositions not comprising PVP were taken to pH=2 and thereafter were treated with PVP, only a partial recovery of luminescence intensity was observed in agreement with previous reports (−10% of luminescence intensity at pH=7). In contrast, as discussed hereinabove, when PVP was part of the SWNT/SDBS composition prior to acidification, enhancement in luminescent intensity at pH=2 was observed.

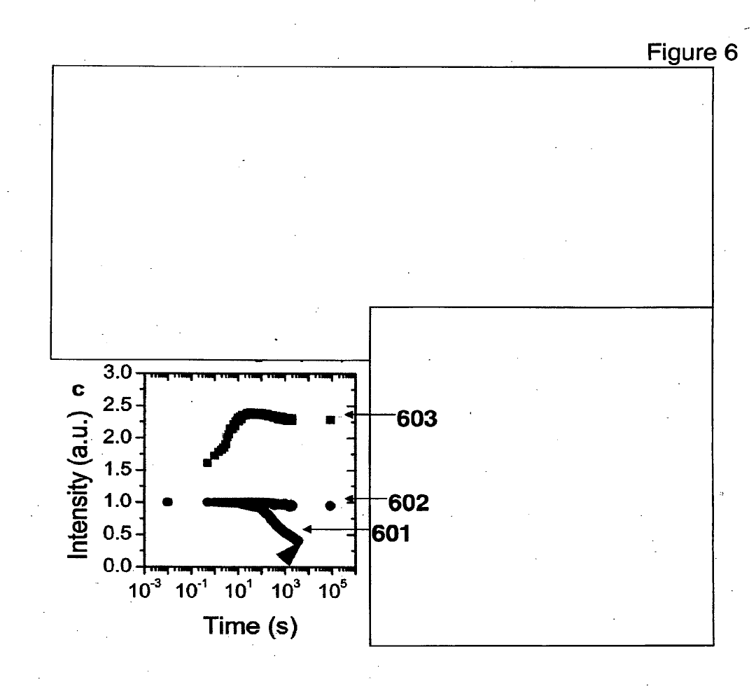

An embodiment of the kinetic time course for the fluorescence intensity of SWNT/SBDS, SWNT/PVP, and SWNT/SDBS/PVP at 1120 nm following the addition of acid was also measured as shown in FIG. 6. Fluorescence intensities were normalized to the initial intensity of each composition at pH=7. For about the first 200 seconds, there was little change in the fluorescence intensity of SWNT/SDBS 601 before decreasing in intensity considerably. The carbon nanotubes from this composition also flocculated out of solution past this time. The time to the onset of flocculation can vary from minutes to hours depending on the amount of acid and surfactant concentration. Not being bound by theory, it is believed that acidic conditions result in destabilization of the SWNT/SDBS micelle, which creates openings for the acid to contact the SWNT and quench fluorescence. As shown in FIG. 6, SWNT/PVP suspensions 602 were relatively unaffected by acidification, as shown by only about a 5% drop in fluorescence intensity over 24 hours. However, the absolute fluorescence intensity of SWNT/PVP suspensions was only about 3% of that observed for SWNT/SDBS. The fluorescence intensity of the SWNT/SDBS/PVP 603 clearly indicated distinguishing features over the other two compositions. Spectrum 603 demonstrated strong fluorescence between pH 1 and pH 11. Upon addition of acid, the fluorescent peak intensity increased rapidly until stabilizing at about twice the initial fluorescence level.

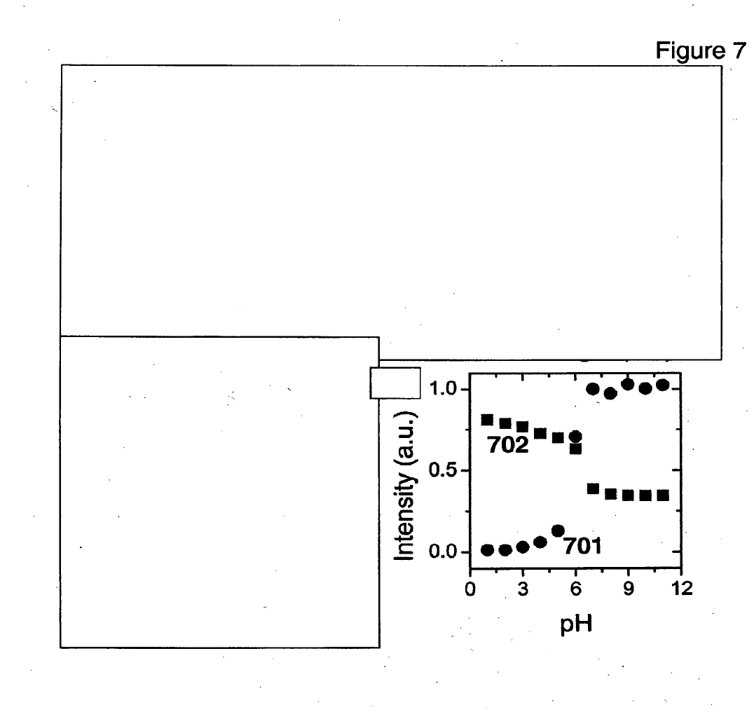

The variance of SWNT/SDBS and SWNT/SDBS/PVP fluorescence intensity between pH 1 and 11 is presented in FIG. 7. Both curves were normalized to the fluorescence intensity of SWNT/SDBS at neutral pH for this analysis. Both SWNT/SDBS fluorescence 701 and SWNT/SDBS/PVP fluorescence 702 remained fairly constant between pH=7 and pH=11. SWNT/SDBS fluorescence intensity 701 was more intense at alkaline pH than was SWNT/SDBS/PVP fluorescence intensity 702. In contrast, the relative intensity of SDBS/SWNT fluorescence intensity 701 decreased gradually in acidic solutions as the pH was lowered to pH=1 with flocculation subsequently occurring. SWNT/SDBS/PVP fluorescence intensity 702 increased continuously as the pH was lowered to reach about 80% of the SWNT/SDBS fluorescence intensity 701 at pH=7. The SWNT/SDBS/PVP fluorescence intensity 702 remained stable for weeks over the entire pH range tested.

Charge of the surfactant influenced interaction with PVP. When PVP was added to SWNTs suspended in CTAB (cationic surfactant) or Pluronics (neutral surfactant), no spectral changes were observed. Photobleaching of SWNT/CTAB/PVP suspensions was also observed at acidic pH. Together the data presented hereinabove is consistent with an understanding that in SWNT/SDBS/PVP suspensions, SDBS remains around the SWNTs after the addition of PVP and is not replaced by PVP. Not to be limited by theory, the data is consistent with formation of a stable surfactant-polymer complex that provides an efficient and stable bather between the SWNTs and their local environment. Although cationic and neutral surfactants do not protect SWNTs against spectral changes when mixed with PVP, mixture cationic or neutral surfactants with a complementary polymer will provide such protection based on an understanding of the interaction of SDBS with PVP. In a non-limiting example, combination of CTAB (a quaternary ammonium salt) will interact with an anion-containing polymer, such as one containing carboxylate, phenolate, or sulfonate moieties. In certain embodiments of the disclosure, an anionic surfactant forms a complex with a polymer capable of bearing a positive charge. In other embodiments of the disclosure, a cationic surfactant forms a complex with a polymer capable of bearing a negative charge. In still other embodiments of the disclosure, a surfactant and polymer form a complex that is unrelated to the charge of either component. The approach described hereinabove suggests a generalized approach for engineering a variety of specialized SWNT biocompatible platforms based upon a surfactant/polymer combination having desired properties for a given application.

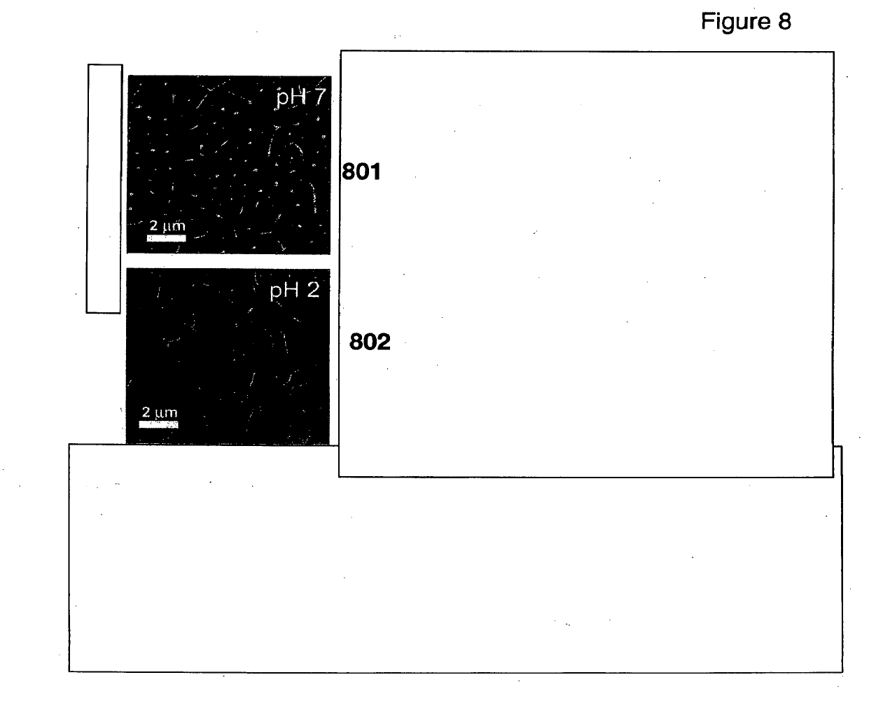

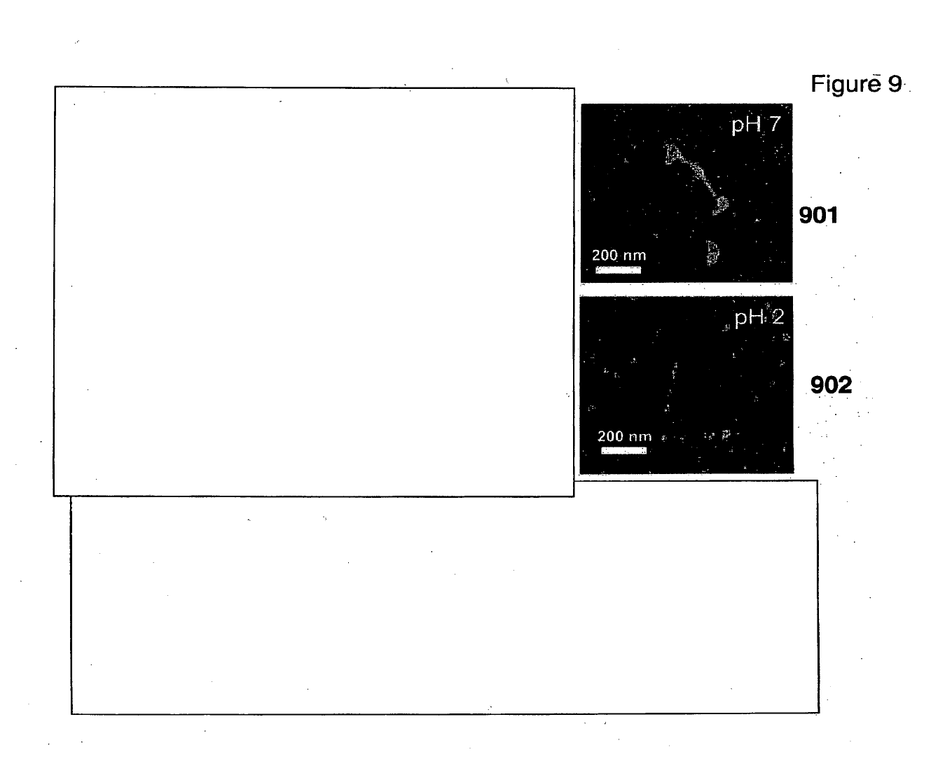

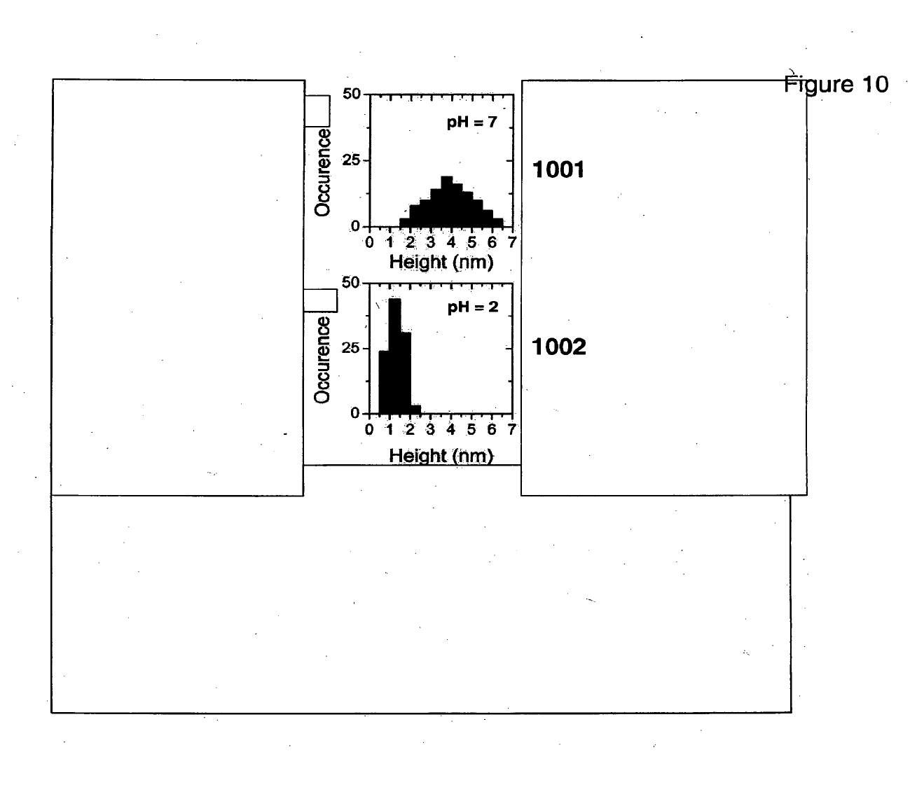

Photophysical properties of individual nanotubes from the SWNT/SDBS/PVP compositions were measured as well. FIGS. 8 and 9 show embodiments of AFM images of SWNT/SDBS/PVP compositions prepared at pH=7 and pH=2, respectively, both before (801 and 901) and after (802 and 902) surface cleaning of excess surfactant and PVP. These images support the assertion the SWNTs exist as individuals in the compositions disclosed herein. This conclusion is also supported by Cryo-TEM measurements. The AFM images of the compositions which had not been cleaned of excess surfactant and PVP (901 and 902) suggest large agglomerates at both pH=7 (apparent height>10 nm) and pH=2 (apparent height about 6 nm). Embodiments apparent height distribution measurements of the compositions at pH=7 (1001) and pH=2 (1002) after surface cleaning are shown in FIG. 10. At pH=7, the SWNTs were surrounded by a bulkier structure than at pH=2. At pH=7, the apparent height was 3.9±0.1 nm (n=102). At pH=2, the apparent height was 1.3±0.04 (n=102).

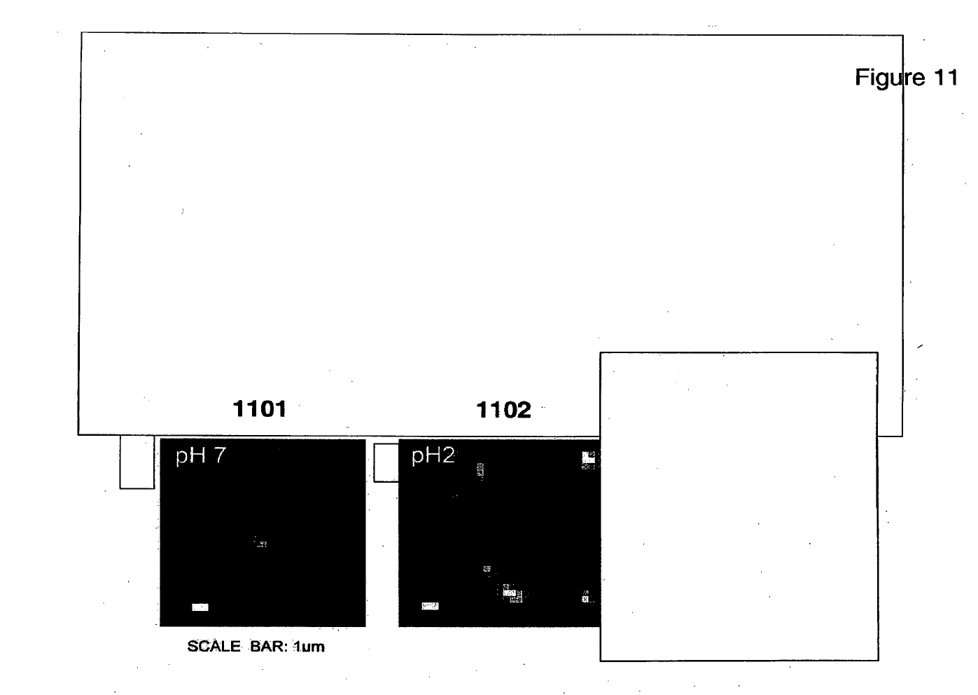

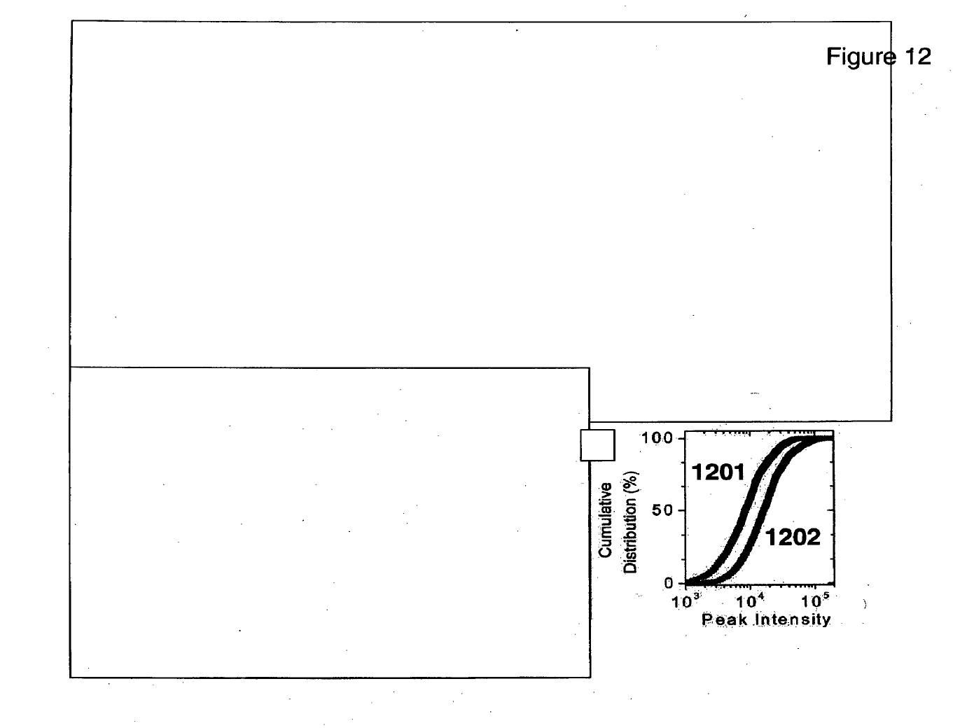

The photoluminescence of the SWNT/SDBS/PVP compositions was further investigated by direct visualization through near-IR microscopy as shown in embodiments of FIG. 11. The majority of the luminescence spots originates from individual SWNTs and is diffraction limited (2 pixels correspond to 670 nun in FIG. 11), which indicates that most of the spots have a length shorter than about 670 nm. Images in the near-IR images at pH=2 (1102) were qualitatively brighter than those at pH=7 (1101). This observation was quantified in the embodiments shown in FIG. 12, which shows the cumulative distributions of individual fluorescent spot signal amplitudes obtained for pH=7 (1201) and pH=2 (1202). The signals were obtained from statistical fit of each spot's spatial distribution by a 2-D Gaussian function. The widths of the distributions were nearly identical and broad. The embodiments shown in FIG. 12 further support fluorescent enhancement of SWNT/SDBS/PVP compositions at acidic pH. The ratio of the two intensity distributions shown in FIG. 12 was about 1.9, which is in good agreement with the fluorescence enhancement observed in bulk samples using the same excitation at 660 nm (see FIG. 2).

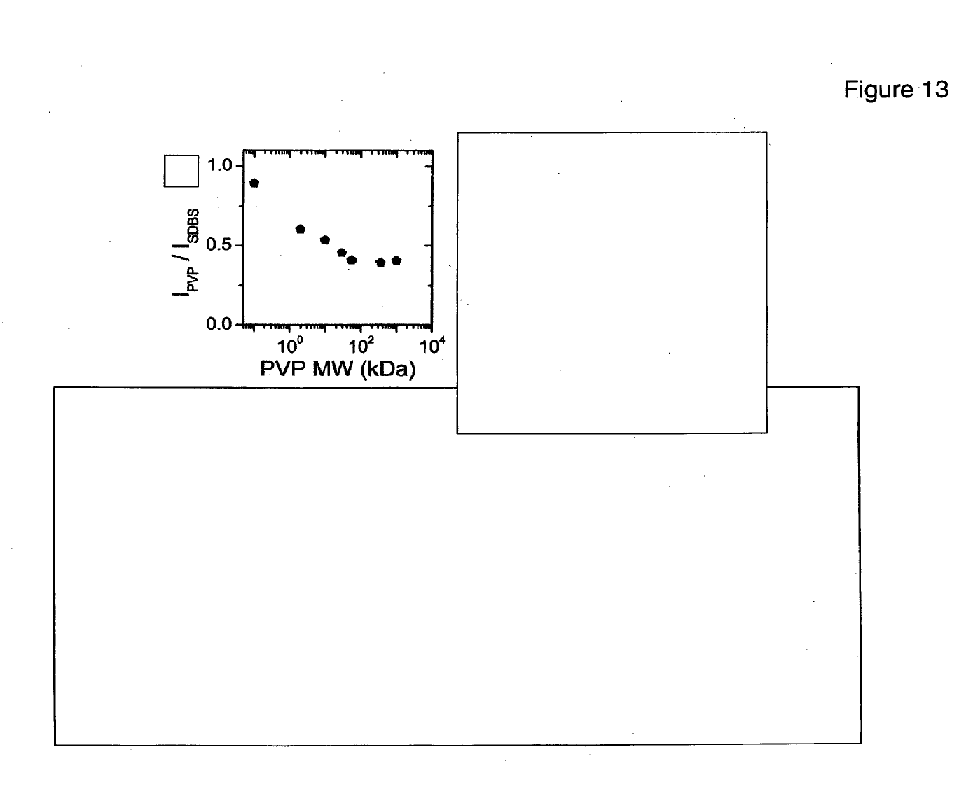

The influence of PVP molecular weight on fluorescence intensity was also measured. FIG. 13 shows embodiments of the ratio of SWNT/SDBS/PVP to SWNT/SDBS integrated fluorescence intensity (excited at 660 nm and measured at pH=7) as a function of PVP molecular weight. The molecular weight range studied varied from vinyl pyrrolidone monomer to 1 MDa. As shown in FIG. 13, the measured ratio decreased as a function of molecular weight from monomer to about 55 kDa. The molecular weight dependence indicates that the size and conformation of the PVP surrounding the SWNTs has an influence on the observed optical properties.

The arrangement of PVP on the SWNT/SDBS complex may be controlled by direct polymerization of vinyl pyrrolidone directly on the micelle structure. Vinyl pyrrolidone is known to undergo cationic polymerization that is slow at pH=7 but much more rapid at low pH values. PVP may be introduced to the compositions disclosed herein by introducing vinyl pyrrolidone to SWNT/SDBS suspensions at pH=7, allowing sufficient time for diffusion of vinyl pyrrolidone to the SWNT/SDBS micelles to occur, and subsequently acidifying the solution to initiate polymerization. The progress of the polymerization reaction may be monitored spectroscopically, such as by Raman spectroscopy, in a non-limiting monitoring method. For example, the C═C peak may be monitored at 1638 cm⁻¹ in order to monitor disappearance of the monomer in the polymerization reaction to produce PVP. In order to produce biocompatible compositions, complete polymerization is beneficial in some instances, since polymerized material may be biocompatible whereas the small molecule monomer may not be biocompatible.

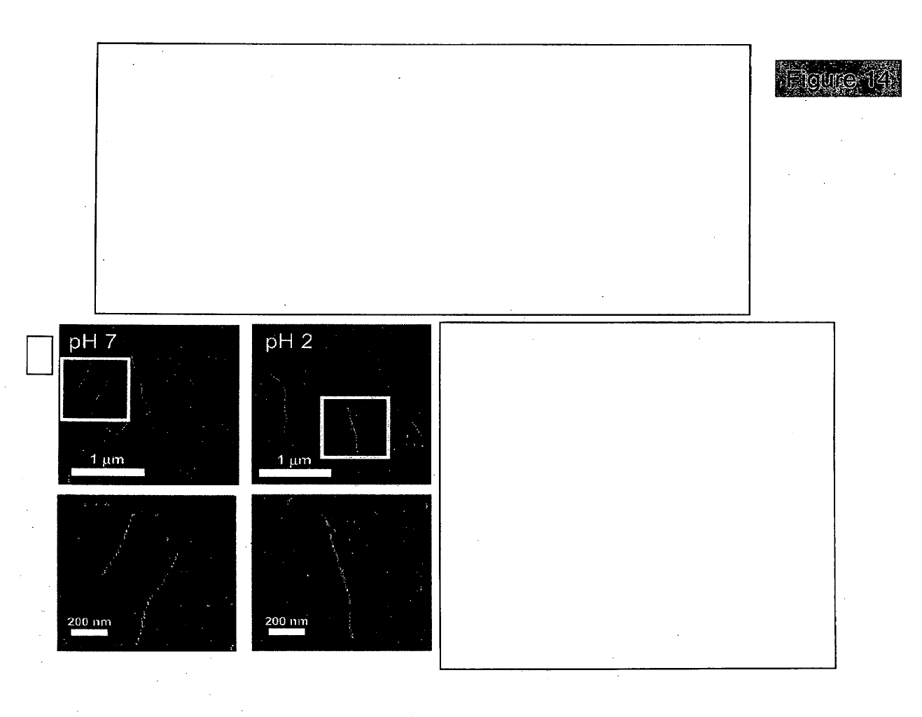

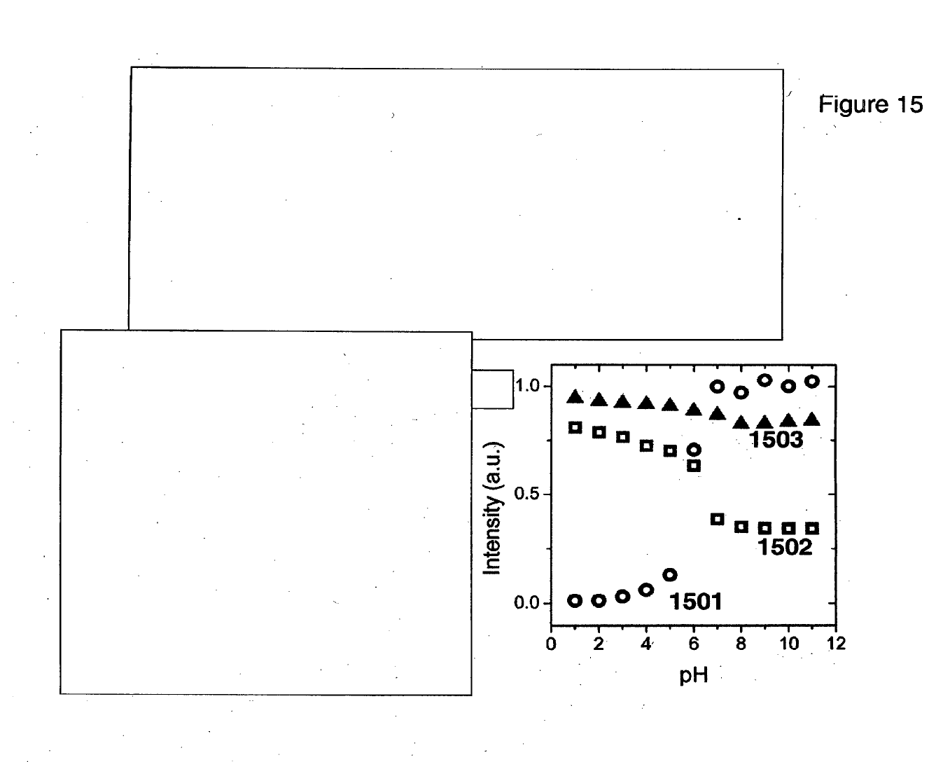

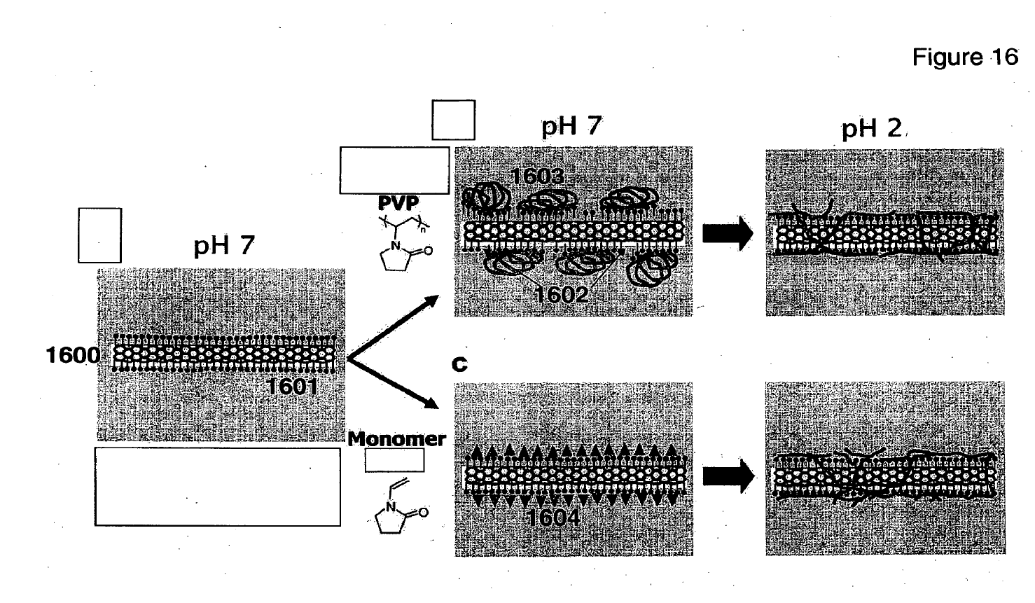

FIG. 14 shows that the embodiments of AFM images obtained from SWNT/SDBS/PVP prepared by in situ polymerization of vinyl pyrrolidone are comparable to those obtained from pre-formed PVP (FIGS. 8 and 9). Image 1401 is for SWNT/SDBS/PVP at pH=7 following surface cleaning. Image 1402 is for SWNT/SDBS/PVP at pH=2 following surface cleaning. Image 1403 is a high magnification image of the inset noted in image 1401. Image 1404 is a high magnification image of the inset noted in image 1402. FIG. 15 shows that SWNT/SDBS/PVP compositions prepared by in situ polymerization of vinyl pyrrolidone possess a beneficial property over compositions prepared from pre-formed PVP polymer. The relative fluorescence intensity of SWNT/SDBS/PVP prepared by in situ polymerization (1503) showed considerably less change over a measured pH range of 1 to 11, compared to a similar composition described hereinabove prepared from pre-formed PVP. Data for SWNT/SDBS (1501) and SWNT/SDBS/PVP (1502) presented in FIG. 15 is that previously presented in FIG. 7. Relative fluorescence intensity for SWNT/SDS/PVP prepared by in situ polymerization (1503) was comparable to that obtained for SWNT/SDBS (1501), except the fluorescence was much more constant over the entire pH range studied. The small residual red shifts (<10 nm) and marginal dependence on pH is consistent with an understanding that in situ polymerized PVP interacts strongly with SWNT/SDBS micelles but without disrupting the initially obtained SDBS/SWNT micelle. In contrast the data presented herein is consistent with a disruption of SWNT/SDBS micelles by exposure to pre-formed PVP. The disruption is thought to be due to a conformational change. Control experiments with non-polymerizable pyrrolidone molecules (1-methyl-2-pyrrolidone and 1-ethyl-2-pyrrolidone) did not protect the SWNTs against photobleaching at low pH. A proposed but non-limiting mechanistic schematic demonstrating how pre-formed PVP and vinyl pyrrolidone interact with SWNT/SDBC micelles is shown in FIG. 16. As shown in FIG. 16, PVP polymer chains (1603) induce an initial conformational change (1602) of the SDBS molecules (1601) surrounding the SWNT (1600) during their coating the SWNT/SDBS micelle. In contrast, the vinyl pyrrolidone monomers (1604) do not disrupt the SDBS micelle conformation during coating of the SWNT/SDBS micelles prior to the polymerization reaction.

This model presented in FIG. 16 is consistent with an understanding that the SDBS/PVP interactions resulting from in situ polymerization strengthen the micelle structure and therefore beneficially protect the nanotube from different types of environmental factors, which would be useful for a variety of applications. For example, the compositions prepared by in situ vinyl pyrrolidone polymerization maintained stable luminescence far below the critical micelle concentration (cmc) of SDBS. Further, salinity of the dissolution medium did not influence the luminescence properties as evidenced by stability in 10× phosphate buffered saline.

In certain embodiments of the compositions disclosed herein, the at least one polymer is pre-formed. In other embodiments of the compositions disclosed herein, the at least one polymer is formed in situ from at least one monomer. In still other embodiments of the compositions disclosed herein, the at least one polymer is selected from a group consisting of PVP, derivatives thereof, and combinations thereof. In some embodiments of the compositions disclosed herein, the at least one polymer is biocompatible. In an embodiment, the at least one polymer comprises PVP. The PVP may be utilized in the compositions herein as either the pre-formed polymer or formed through in situ polymerization of vinyl pyrrolidone.

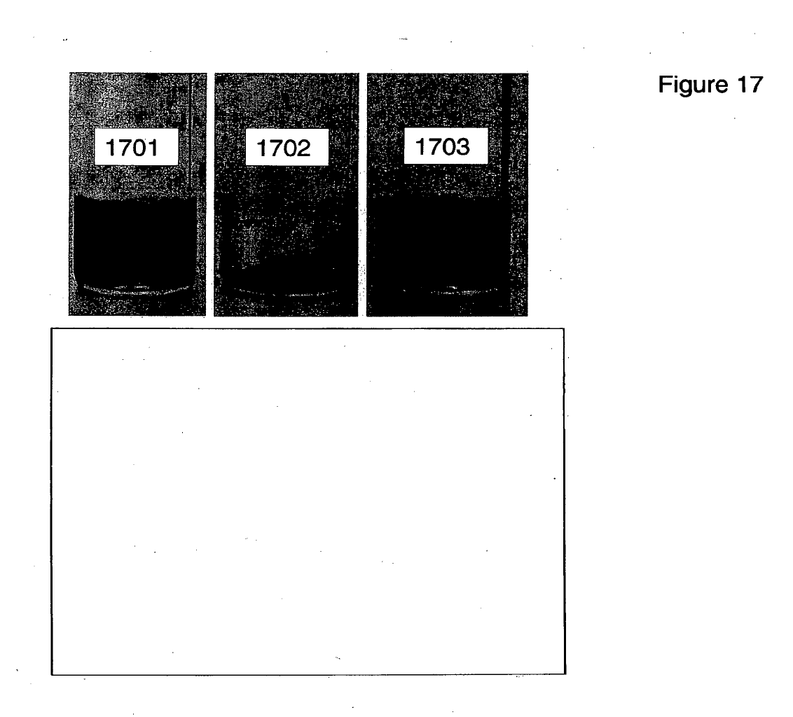

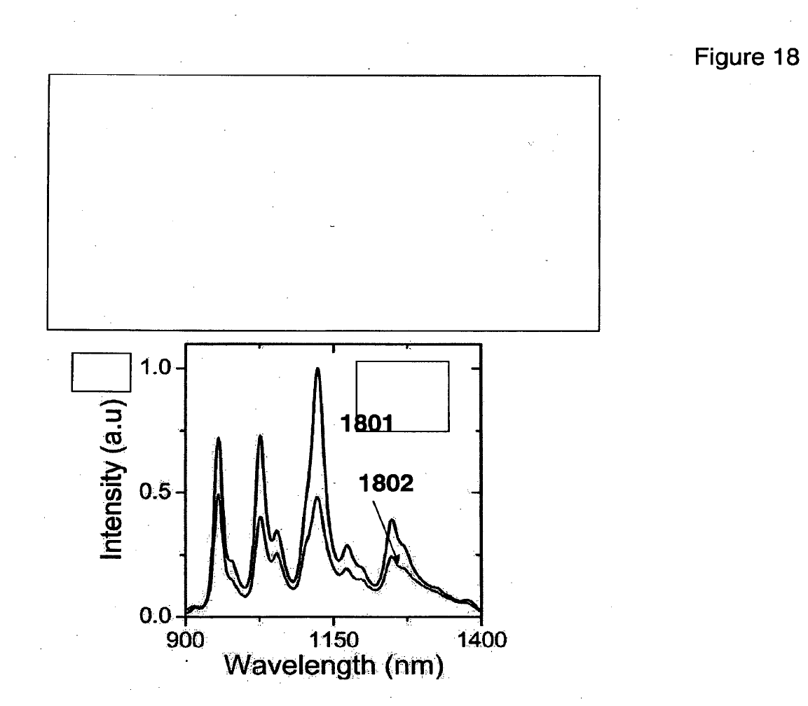

To further examine the stability of the SWNT/SDBS/PVP compositions, freeze-drying of the compositions was performed at neutral pH to produce a solid, followed by re-suspension of the solid in water by mild shaking. FIG. 17 shows that the SWNT/SDBS/PVP suspension (1701) can be completely lyophilized to a solid (1702) and then re-suspended (1703). As shown in the embodiments of FIG. 18, the positions of the spectroscopic peaks remained unchanged, although a modest loss in intensity occurred following re-suspension (1802) compared to the suspension fluorescence intensity prior to lyophilization (1801). Loss of intensity following resuspension could be due to a small amount of flocculation, although bright field optical microscopy (63×) did not reveal such behavior. The SWNT/SDBS/PVP compositions disclosed herein provide an advantageous benefit over SWNT/SDBS in this regard, since the latter composition cannot be resuspended following lyophilization.

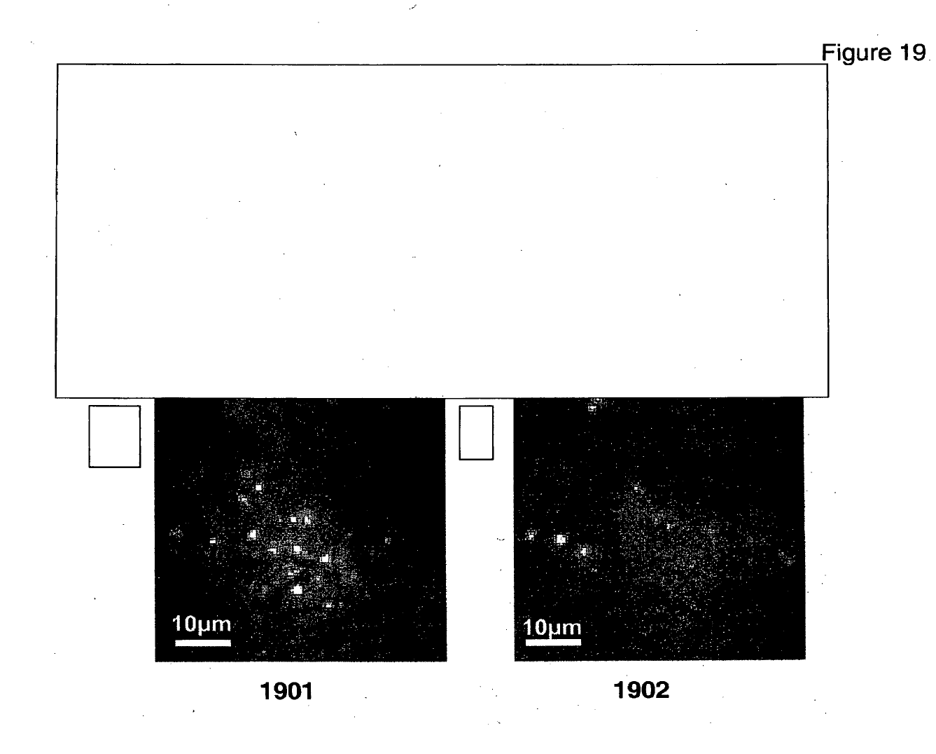

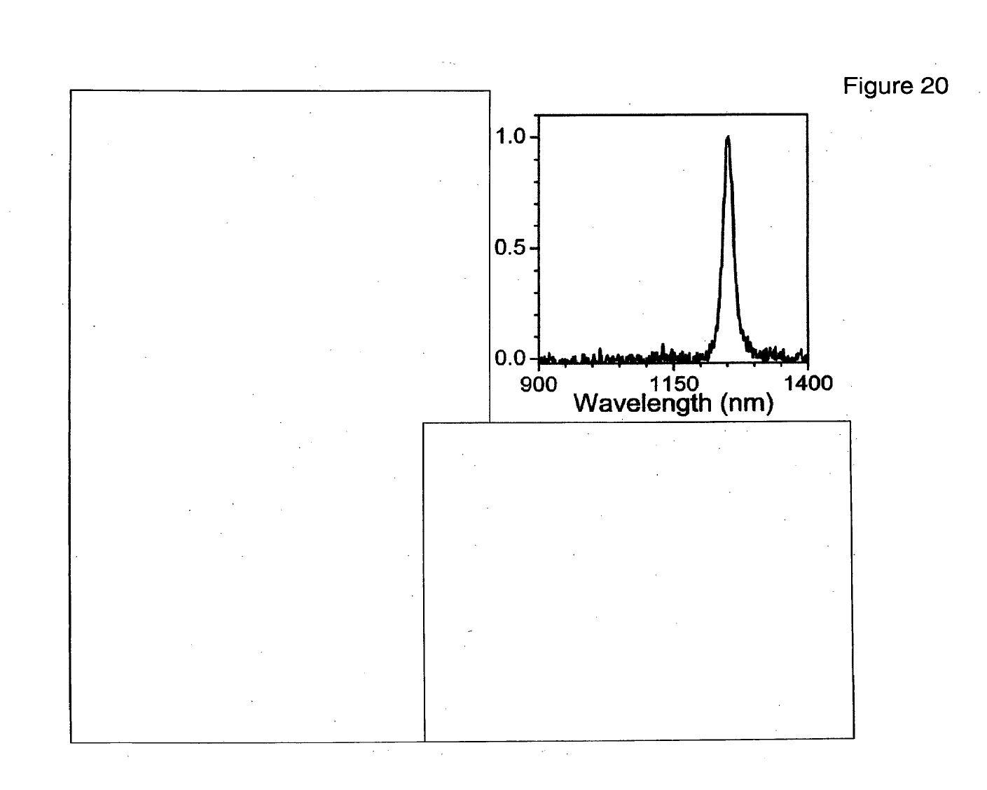

The properties of the SWNT/SDBS/PVP compositions were examined in a biological environment by exposure to live cultured HEK293 cells. Exposure was conducted for either 5 minutes at room temperature or for 37° C. overnight. FIG. 19 shows an embodiment of near-IR luminescence images of a cell recorded at two different foci after 5 minutes of incubation with the SWNT/SDBS/PVP composition. Image 1901 is at the apical membrane, and image 1902 is at the surface of the coverslip. Images were obtained in the presence of white light to identify the outline of the cell. Highly luminescent and diffraction limited spots originating from individual SWNTs interacting with the surface of the cells are shown. These spots demonstrate polarized absorption as evidenced using a rotating linearly polarized excitation. FIG. 20 shows a fluorescence spectrum originating from a luminescent spot on the cell surface. The narrow fluorescence spectrum supports the presence of individual SWNTs on the cell surface. Comparable results were obtained after 12 hours of incubation at 37° C.

The electromagnetic radiation absorption and emission properties of the compositions disclosed herein are beneficial for applications utilizing the compositions. In certain embodiments disclosed herein, the compositions comprise a drug delivery vehicle. A non-limiting example of using the compositions disclosed herein as a drug delivery vehicle comprises administering the compositions to a living subject and then irradiating the carbon nanotubes such that they absorb electromagnetic radiation. Localization of the compositions in a cancerous tissue or a plaque provides directed therapy by cell killing or plaque ablation by carbon nanotube heating.

In certain embodiments, the compositions disclosed herein comprise a biosensor. In these embodiments, emission of electromagnetic radiation is used for detecting the carbon nanotubes in a living organism. Likewise, in certain embodiments herein, the compositions comprise a biomedical device. Use of the compositions as a biomedical device comprises detection of their fluorescent emission in a non-limiting example.

In other various embodiments, methods are disclosed herein, wherein the methods comprise: obtaining at least one type of carbon nanotube; suspending the at least one type of carbon nanotube, wherein the suspending step takes place in an aqueous solution comprising at least one surfactant; adding at least one polymer; and coating the at least one type of carbon nanotube with the at least one polymer, wherein the coating step creates at least one type of coated carbon nanotube.

In still other embodiments, methods are disclosed herein, wherein the methods comprise: obtaining at least one type of carbon nanotube; suspending the at least one type of carbon nanotube, wherein the suspending step takes place in an aqueous solution comprising at least one surfactant; adding at least one monomer of at least one polymer; coating the at least one type of carbon nanotube with the at least one monomer; and polymerizing the at least one monomer, wherein the polymerizing step creates at least one type of coated carbon nanotube.

In certain embodiments of the methods disclosed hereinabove, the at least one type of carbon nanotube is selected from a group consisting of single-wall carbon nanotubes, double-wall carbon nanotubes, multi-wall carbon nanotubes, unfunctionalized carbon nanotubes, functionalized carbon nanotubes, end-cap functionalized carbon nanotubes, sidewall functionalized carbon nanotubes, shortened carbon nanotubes and combinations thereof.

In certain embodiments of the methods disclosed hereinabove, the at least one surfactant comprises at least one anionic surfactant. In some embodiments of the methods, the at least one anionic surfactant is selected from a group consisting of sulfates, sulfonates, carboxylates, and combinations thereof. In other embodiments of the methods, the at least one anionic surfactant is selected from a group consisting of SDS, SDBS, and combinations thereof.

In certain embodiments of the methods disclosed hereinabove, the at least one polymer is selected from a group consisting of PVP, derivatives thereof, and combinations thereof. In some embodiments of the methods, the at least one polymer is biocompatible. Polymers may be pre-formed or synthesized from monomers containing polymerizable functional groups. The monomer itself need not necessarily be biocompatible, but the polymer formed comprises a biocompatible polymer in an embodiment. The polymerizing step of the methods disclosed hereinabove may be carried out through methods well known to those of skill in the art. In some embodiments, the polymerizing step comprises cationic polymerization. In some embodiments, the cationic polymerization is initiated by a component selected from a group consisting of mineral acids, bases, Lewis acids, and ammonium persulfate. In some embodiments, the cationic polymerization is initiated by HCl.

In some embodiments of the methods disclosed hereinabove, the methods further comprise lyophilizing the at least one type of coated carbon nanotube, wherein lyophilizing creates a solid. Solids comprising coated carbon nanotubes created in this manner may be stored in a stable state until the solid is needed for use in an application. Storage of the solids may take place at room temperature or below. In additional embodiments of the methods disclosed hereinabove, the methods further comprise re-suspending the solid in a solvent comprising water. The lyophilized compositions described hereinabove are advantageous in retaining their fluorescence properties following lyophilization and re-suspension.

In some embodiments disclosed herein, heating methods are disclosed. The heating methods comprise providing a composition comprising at least one type of carbon nanotube, at least one surfactant, and at least one polymer to a material. The methods also comprise irradiating the composition with at least one frequency of electromagnetic radiation. In certain embodiments, the material comprises biological matter. In some embodiments, biological matter may comprise living tissue, such as but not limited to, tumor tissue. In some embodiments of the methods, the composition absorbs the at least one frequency of electromagnetic radiation during the irradiating step. In certain embodiments, the heating methods comprise cancer treatments. Localization of the compositions disclosed hereinabove in a tumor followed by heating through irradiating may beneficially kill tumor cells. In other embodiments, the heating methods comprise plaque ablation treatments. Certain plaques may line the arterial walls in individuals having coronary artery disease. Localization of the compositions disclosed hereinabove on the plaques followed by heating through irradiating may be an effective way of removing these plaques.

### EXPERIMENTAL EXAMPLES

The following experimental examples are included to demonstrate particular aspects of the present disclosure. It should be appreciated by those of skill in the art that the methods described in the examples that follow merely represent exemplary embodiments of the disclosure. Those of skill in the art should, in light of the present disclosure, appreciate that many changes can be made in the specific embodiments described and still obtain a like or similar result without departing from the spirit and scope of the present disclosure.

### Example 1

### Preparation of PVP-Surfactant-Carbon Nanotube Suspensions

Suspensions of HiPco tubes were dispersed in one weight percent (wt %) anionic (SDBS, C₁₈H₂₉O₃SNa; SDS, C₁₂H₂₅O₄SNa), neutral (Pluronicsw (F88, (C₅H₁₀O₂)ₙ)), or cationic (cetyltrimethylammonium bromide (CTAB, C₁₉H₄₂NBr)) surfactants as well as in polymers (PVP, (C₆H₈ON)ₙ) alone using homogenization, ultrasonication, and ultracentrifugation following standard literature methods. All suspensions were characterized spectroscopically and by atomic force microscopy (AFM) to ensure that the SWNTs were predominantly suspended as individuals. Suspensions in SDBS, SDS, Pluronic, and CTAB were added to 1 wt % PVP or 1 wt % vinyl pyrrolidone to obtain suspensions mixed with the polymer or monomer coating agents. The surfactant-polymer molar ratio was maintained above the cmc for all surfactants used (SDBS, cmc=1.6 mM; SDS, cmc=8.35 mM; F88, cmc=1.6 mM; and CTAB, cmc=1.3 mM). Suspensions of coating agents were prepared using one part SWNT-surfactant and three parts PVP to result in a final concentration of 10 mg/L SWNT, 0.25 wt % surfactant, and 0.75 wt % PVP or vinyl pyrrolidone. All spectroscopic measurements were performed on 1 mL samples in a sterile cuvette.

### Example 2

### Measurement of Optical Properties

Fluorescence, absorbance, and liquid-phase Raman measurements were first performed on the carbon nanotube suspensions at neutral pH values. Successive additions of 1 μL it aliquots of 1 M hydrochloric acid (HCl) or 1 M KOH were then added until a desired pH was reached. Bulk fluorescence and absorbance measurements were measured with a Nanospectralyzer Model NS1, version 1.97 (Applied Nanofluorescence). The SWNT fluorescence was excited at 660 nm, and emission was detected between 900 and 1400 nm. Absorbance was measured in the visible and near-IR (400-1400 nm) with integration times of 500 ms and 10 accumulations used in both cases. Absorbance at 763 nm was used to normalize the fluorescence spectra. Liquid phase Raman spectroscopy was performed using a 785 nm laser excitation in a Renishaw system fitted with a microscope. Spectra were collected with a Renishaw Raman Macro Sampling Set (Wire 2 software) between 100 and 3200 cm-l with a 10 s exposure time and 1 accumulation. Time-dependent luminescence spectra of SWNT suspensions in SDBS, PVP, or PVP-SDBS were taken every 0.5 s (50 ms exposure time and 6 accumulations) using a 660 nm laser excitation. Successive measurements began immediately after a SWNT suspension at neutral pH was injected into 10 μL of 1 M HCl.

### Example 3

### Near IR Fluorescence Microscopy of Individual SWNTs

Individual semi-conducting SWNTs were visualized by near-IR fluorescence microscopy. Prior to imaging, a 5 μL drop of the carbon nanotube suspension was placed between a glass slide and a microscope coverslip sealed with silicon grease to prevent drying. SWNT samples were mounted onto an inverted epifluorescence microscope (Nikon TE-2000) equipped with a 60× oil emersion objective (NA=1.4, Nikon). Samples were continuously excited by a circularly polarized beam of a 658 nm diode laser. The infrared photoluminescence emitted by the SWNTs passed through long-pass infrared filters (LP950, Thorlabs) and was detected by a liquid nitrogen-cooled camera (16-bit InGaAs 2D array, OMA-V 2D, Princeton Instruments). Single frame acquisition images of the SWNT luminescence were recorded with an integration time of 50 ms.

### Example 4

### Cell Culture

HEK293 cells were cultured on microscope cover slips in DMEM medium supplemented with streptomycin (100 μg/mL), penicillin (100 U/mL), and 10% bovine serum in a humidified atmosphere (95%):CO₂ (5%) at 37° C. Cells were used for 12-14 passages and were transferred every 4-6 days. Cells were exposed to 50 μL of in situ polymerized SWNT/SDBS/PVP suspension (1 μg/mL added to 1.5 mL of culture medium) for either 5 min at room temperature or 12 h at 37° C. The cells were then washed with fresh medium. The cover slips were mounted in with culture medium, and all data were taken at room temperature.

### Example 5

### AFM Images

AFM images were taken using a Nanoscope IIIc system (Veeco/Digital Instruments) in tapping mode at a scan rate of 2 Hz and scan size of 10 μm. A total of 20 μL of SWNT suspensions was spin coated at 3000 rpm onto a freshly cleaved mica surface (Ted Pella, Inc.) and rinsed with DI water.

### Example 6

### Lyophilization and Resuspension

Lyophilization was performed using a Freezemobile 3+SL (The Virtis Company). A total of 1 mL of SWNT/SDBS/PVP (prepared by in situ polymerization) was freeze-dried at −40° C. for 12 h. Resuspension was accomplished by the addition of 1 mL of deionized water and mild shaking.

From the foregoing description, one skilled in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure, which is defined in the following claims.

What is claimed is:

1. A composition comprising:
a) at least one type of carbon nanotube;
b) at least one surfactant; and
c) at least one polymer;
wherein the composition displays fluorescence over a pH range between about 1 and about 11.

2. The composition of claim 1, wherein the at least one type of carbon nanotube is selected from the group consisting of single-wall carbon nanotubes, double-wall carbon nanotubes, multi-wall carbon nanotubes, unfunctionalized carbon nanotubes, functionalized carbon nanotubes, end-cap functionalized carbon nanotubes, sidewall functionalized carbon nanotubes, and shortened carbon nanotubes.

3. The composition of claim 1, wherein the at least one type of carbon nanotube comprises essentially debundled carbon nanotubes.

4. The composition of claim 1, wherein the at least one surfactant comprises at least one anionic surfactant.

5. The composition of claim 4, wherein the at least one anionic surfactant is selected from the group consisting of sulfates, sulfonates, carboxylates, and combinations thereof.

6. The composition of claim 4, wherein the at least one anionic surfactant is selected from the group consisting of sodium dodecyl sulfate (SDS), sodium dodecylbenzene sulfonate (SDBS), and combinations thereof.

7. The composition of claim 1, wherein the composition is biocompatible.

8. The composition of claim 1, wherein the composition displays a higher fluorescence intensity at acidic pH than at neutral pH.

9. (canceled)

10. (canceled)

11. (canceled)

12. The composition of claim 1, wherein the composition is suspendable in an aqueous solution.

13. The composition of claim 1, wherein the composition absorbs at least one type of electromagnetic radiation selected from the group consisting of radio frequencies and microwave frequencies.

14. (canceled)

15. (canceled)

16. (canceled)

17. The composition of claim 1, wherein the at least one polymer is biocompatible.

18. The composition of claim 1, wherein the at least one polymer is selected from the group consisting of poly(vinylpyrrolidone) (PVP), derivatives thereof, and combinations thereof.

19. A method comprising:
a) obtaining at least one type of carbon nanotube;
b) suspending the at least one type of carbon nanotube in an aqueous solution comprising at least one surfactant;
c) adding at least one polymer to the aqueous solution;
d) coating the at least one type of carbon nanotube with the at least one polymer to form at least one type of polymer coated carbon nanotube;
wherein the at least one type of polymer coated carbon nanotube displays fluorescence over a pH range between about 1 and about 11.

20. A method comprising:
a) obtaining at least one type of carbon nanotube;
b) suspending the at least one type of carbon in an aqueous solution comprising at least one surfactant;
wherein the at least one type of carbon nanotube and the at least one surfactant form a micelle structure in the aqueous solution;
c) adding at least one monomer to the aqueous solution;
d) coating the micelle structure with the at least one monomer; and
e) polymerizing the at least one monomer to form at least one polymer comprising at least one type of polymer coated carbon nanotube;
wherein the at least one type of polymer coated carbon nanotube displays fluorescence over a pH range between about 1 and about 11.

21. The method of claim 20, wherein the at least one type of carbon nanotube is selected from the group consisting of single-wall carbon nanotubes, double-wall carbon nanotubes, multi-wall carbon nanotubes, unfunctionalized carbon nanotubes, functionalized carbon nanotubes, end-cap functionalized carbon nanotubes, sidewall functionalized carbon nanotubes, and shortened carbon nanotubes.

22. The method of claim 20, wherein the at least one surfactant comprises at least one anionic surfactant.

23. The method of claim 22, wherein the at least one anionic surfactant is selected from the group consisting of sulfates, sulfonates, carboxylates, and combinations thereof.

24. The method of claim 22, wherein at least one anionic surfactant is selected from the group consisting of sodium dodecyl sulfate (SDS), sodium dodecylbenzene sulfonate (SDBS), and combinations thereof.

25. The method of claim 20, wherein the at least one polymer is biocompatible.

26. The method of claim 20, wherein the at least one polymer is selected from the group consisting of poly(vinylpyrrolidone) (PVP), derivatives thereof, and combinations thereof.

27. The method of claim 20, wherein polymerizing the at least one monomer takes place by cationic polymerization.

28. The method of claim 27, wherein the cationic polymerization is initiated by a component selected from the group consisting of mineral acids, bases, Lewis acids, and ammonium persulfate.

29. The method of claim 27, wherein the cationic polymerization is initiated by HCl.

30. The method of claim 20, further comprising:
lyophilizing the aqueous solution after polymerizing the at least one monomer to form a solid.

31. The method of claim 30, further comprising:
re-suspending the solid in a solvent comprising water.

32. (canceled)

33. (canceled)

34. (canceled)

35. (canceled)

36. (canceled)

37. The composition of claim 1, wherein the at least one surfactant and the at least one polymer form a complex that creates a barrier around the at least one type of carbon nanotube.

38. The composition of claim 37, wherein the at least one surfactant is an anionic surfactant and the at least one polymer is operable for bearing a positive charge.

39. The composition of claim 37, wherein the at least one surfactant is a cationic surfactant and the at least one polymer is operable for bearing a negative charge.

40. The composition of claim 1, wherein the at least one type of carbon nanotube and the at least one surfactant form a micelle structure; and
wherein the at least one polymer is formed in situ on the micelle structure.

41. The composition of claim 1, wherein the composition is dispersible in an aqueous solution; and
wherein the aqueous solution is lyophilizable to a solid.

42. The composition of claim 41, wherein the solid is redispersible in a solution comprising water; and
wherein the solution comprising water displays fluorescence over a pH range between about 1 and about 11.

43. The method of claim 19, wherein the at least one polymer comprises a water-soluble polymer; and
wherein the at least one surfactant comprises at least one anionic surfactant.

44. The method of claim 20, wherein the at least one polymer coats the micelle structure.

45. A biocompatible composition comprising:
a) single-wall carbon nanotubes;
b) at least one anionic surfactant;
wherein the single-wall carbon nanotubes and the at least one anionic surfactant form a micelle structure; and
c) a water-soluble polymer polymerized in situ on the micelle structure;
wherein the composition displays fluorescence over a pH range between about 1 and about 11.
